(19) United States
(12) Patent Application Publication
(10) Pub. No.: US 2023/0356642 A1
(43) Pub. Date: Nov. 9, 2023

(54) PLANAR TRANSPORTATION DEVICE AND METHOD OF OPERATING A PLANAR TRANSPORTATION DEVICE

(71) Applicant: Syntegon Technology GmbH, Waiblingen (DE)

(72) Inventors: Sebastian Schwarz, Neusitz (DE); Matthias Klauser, Stuttgart (DE)

(21) Appl. No.: 18/310,046

(22) Filed: May 1, 2023

(30) Foreign Application Priority Data
May 3, 2022 (DE) 10 2022 110 910.0

(51) Int. Cl. B60P 1/00; B65G 54/02

(52) U.S. Cl. CPC B60P 1/006; B65G 54/02

(57) ABSTRACT

A planar transport device (10) having a driving surface (12) and having at least one first platform (16), which can be coupled electromagnetically to the driving surface and moved parallel to the driving surface. The planar transport device includes a payload space (24) for arrangement of a payload (26).The planar transport device includes an inertial element (30) which is movable relative to the first platform, and the movable inertial element and the payload space are oriented relative to each other such that, upon deceleration of the first platform due to movement of the inertial element in an effective direction relative to the first platform, at least some of the kinetic energy of the inertial element can be transferred to the payload space. A method for operation of a planar transport device is also described.

### BACKGROUND

The invention relates to a planar transport device having a driving surface and having at least one first platform, which can be coupled electromagnetically to the driving surface and moved parallel to the driving surface, wherein the planar transport device comprises a payload space for arrangement of a payload.

From WO 2020/243 814 A1 and DE 10 2020 127 012 A1 there are known planar transport devices with electromagnetically coupled platforms. Such platforms can be used, for example, as simple and flexible transport bodies for the transport of various payloads and/or they can have working devices with a work tool.

In order to transport a payload, the payload is arranged in the payload space of a platform and can then be moved together with the platform over the driving surface. Once the platform has reached a destination within the driving surface, it should be possible to remove the payload from the platform.

For this purpose, WO 2020/243 814 A1 proposes a device, as represented in FIG. 21. This device comprises a first platform having a payload which is to be removed. The device comprises a second platform having a suction element. After a relative orienting of the two platforms, the suction element is brought into contact with the payload and a partial vacuum is applied to it. The payload in this way is held on the suction element and can be removed from the first platform. Since the payload and the suction element are each arranged on movable platforms, this device enables a removal of the payload regardless of its location.

The shortcoming of the aforementioned device is that an energy supply is needed to generate the partial vacuum for the operation of the suction device and a conduit system is needed to transfer the partial vacuum, thus increasing the complexity of such a device. Especially when the energy supply is situated outside the driving surface, a costly guidance of the conduit system must be provided, in order to be able to apply the partial vacuum with the suction element everywhere inside the driving surface.

A further possibility of removing a payload from a platform is shown in FIG. 22 of WO 2020/243 814 A1. In this device, the suction device is not arranged on a second platform, but instead it is stationary. Since the power supply of the suction device can be arranged in direct proximity, this reduces the demands on the conduit system. However, in order to remove the payload, it is necessary to drive the platform carrying the payload into the active zone of the suction device. Thus, a removal of the payload regardless of its position is not possible.

The shortcoming in both of the above-explained devices of WO 2020/243 814 A1 is furthermore the fact that the suction element must be adapted to the shape and/or size of the payload. If payloads having different dimensions or geometries are being transported, the suction element must be changed in an additional work step, or multiple suction devices with different suction elements are required.

### SUMMARY

Starting from this, the problem on which the invention is based is to indicate a device and a method making possible a simple removal of a multitude of different payloads from a platform regardless of position.

This problem is solved, in a planar transport device of the kind mentioned above, in that the planar transport device comprises an inertial element which is movable relative to the first platform, wherein the movable inertial element and the payload space are oriented relative to each other such that, upon deceleration of the first platform due to movement of the inertial element in an effective direction relative to the first platform, at least some of the kinetic energy of the inertial element can be transferred to the payload space.

Thanks to the arrangement of the inertial element on the first platform, it is possible to reach every position of the driving surface without limitation and to transfer at that position the kinetic energy of the inertial element, at least partially, to the payload space. Since, furthermore, the deflection of the inertial element is controlled by the movement of the platform, an intrinsic function of the device—namely, the mobility of the platforms—can be utilized, thereby providing a planar transport device of simple construction. In particular, there is thus no need for an additional actuator (such as a suction device).

Given the placement of a payload in the payload space, upon deceleration of the first platform the kinetic energy of the inertial element is partially transferred to the payload and the payload is removed from the payload space—in particular following the effective direction of the inertial element. It is possible to remove payloads having different shape and/or size and/or different material from the payload space.

In one preferred embodiment, the planar transport device comprises a return device, which moves the inertial element contrary to the effective direction. In this way, the inertial element after a deflection has occurred is returned to its original, nondeflected position and is available for another transfer of kinetic energy. The return device can be fashioned, for example, as a spring element, which is braced against the first platform and connected to the inertial element and which is active contrary to the effective direction of the inertial element. Of course, such a return device need only provide a relatively small restoring force; therefore, the return device only slightly decreases the kinetic energy of the inertial element which can be used for a dropping process.

Especially preferably, the first platform comprises a first linear guide for guidance of the inertial element or an intermediate element, serving for the placement of the inertial element. The linear guide makes possible an especially simple assignment of the effective direction of the inertial element. In particular, when the direction of movement of the platform is oriented parallel to the extension of the linear guide, a maximum portion of the kinetic energy of the inertial element can be transferred to the payload space.

Moreover, it is preferable for the intermediate element to comprise a second linear guide for guidance of the inertial element. Thanks to the second linear guide, a more flexible control of the effective direction of the inertial element is possible. Thus, for example, an effective direction of the inertial element can be set, being composed in part of the direction of movement of the intermediate element along the first linear guide and the direction of movement of the inertial element along the second linear guide.

One preferred embodiment proposes that the first linear guide extends along a first guiding axis, the second linear guide extends along a second guiding axis, and the first guiding axis and the second guiding axis are oriented perpendicular to each other. This provides a simple way of transferring the maximum amount of kinetic energy of the inertial element to the payload space, and this optionally in one of two mutually perpendicular directions.

Furthermore, it is preferable for the intermediate element to be mounted rotatably on the first platform by means of an axis of rotation. Thanks to the axis of rotation, the effective direction of the inertial element in the payload space can be controlled, regardless of the orientation, in particular the rotation, of the platform. In the event that the axis of rotation is offset from the center of gravity of the first platform, it is also possible to influence the rotary position of the intermediate element by a movement of the first platform.

In particular, it is preferable for the payload space to be associated with the at least one first platform. In this way, the inertial element and the payload space are together freely movable within the driving surface by the first platform and in particular the transfer of at least a portion of the kinetic energy of the inertial element to the payload space is possible regardless of position.

It is especially preferable for the inertial element to form, at least in an initial state, an at least partial boundary of the payload space. In this way, a correct orientation of the inertial element, the payload space, and a payload arranged in the payload space is assured. Thanks to the spatial proximity, an especially large portion of the kinetic energy of the inertial element can be transferred to the payload space and to the payload. A payload arranged in the payload space is braced by the inertial element during the movement of the platform and in particular it is protected against unwanted slippage from the payload space.

One preferred embodiment proposes that the payload space is associated with a second platform, which can be coupled electromagnetically to the driving surface and which can move parallel to the driving surface. By associating the payload space with the second platform, the transporting and the removing of the payload can be realized separately from each other. Thus, it is conceivable for different payloads to be transported by second platforms not having any inertial element, while the removing of the payload is done by a first platform having an inertial element.

Moreover, it is preferable for the inertial element to comprise an extension section extending in the effective direction, which extends beyond the first platform at least in a deflected state of the inertial element. In this way, a portion of the kinetic energy of the inertial element can be transferred to a payload region outside of the first platform and in particular to a payload region associated with the second platform.

The invention moreover relates to a method for operating a planar transport device mentioned above. It is proposed that a payload is arranged in the payload space, wherein the movable inertial element and the payload space are oriented relative to each other such that, upon deceleration of the platform due to movement of the inertial element relative to the platform, at least some of the kinetic energy of the inertial element is transferred to the payload space and to the payload.

The method makes possible the transporting and the removal of the payload from the payload space at optionally selected positions of the driving surface. Thanks to the transfer of kinetic energy to the payload, the payload is accelerated and removed from the payload space by ejecting. The transfer of the kinetic energy to the payload can be controlled by the movement of the platform itself. Further benefits and features of the method according to the invention are explained above with reference to benefits and features of the device according to the invention, which are included here by reference.

Furthermore, the invention relates to a method for operating a planar transport device, wherein upon movement of the platform in an x-direction of the driving surface and then a deceleration of the platform, the inertial element moves relative to the intermediate element, and wherein upon movement of the platform in the y-direction of the driving surface, perpendicular to the x-direction of the driving surface, and then a deceleration of the platform, the inertial element moves together with the intermediate element relative to the platform.

Thanks to the mutually perpendicular deflections of the inertial element or the inertial element together with the intermediate element, a maximum portion of the kinetic energy of the inertial element can be transferred in a simple manner to the payload space in two mutually perpendicular directions.

### BRIEF DESCRIPTION OF THE DRAWINGS

Further features and benefits are the subject of the following description and the graphical representation of embodiments.

The drawing shows

FIG. 1 a perspective view of one embodiment of a planar transport device having a first platform and a payload;

FIG. 2 a perspective view of the first platform of FIG. 1 in an initial state;

FIG. 3 a perspective view of the platform of FIG. 1 when ejecting the payload;

FIG. 4 a perspective view of another embodiment of a first platform having an intermediate element and a payload;

FIG. 5 a perspective view of the platform of FIG. 4 when ejecting the payload in the x-direction;

FIG. 6 a perspective view of the platform of FIG. 4 in a state of the intermediate element and the payload deflected in the y-direction;

FIG. 7 a perspective view of the platform of FIG. 4 upon ejecting the payload following the state per FIG. 6;

FIG. 8 a perspective view of another embodiment of a platform having a rotatably mounted intermediate element and a payload;

FIG. 9 a perspective view of the platform of FIG. 8 with a rotated intermediate element;

FIG. 10 a perspective view of the platform of FIG. 8 upon ejecting the payload following the state per FIG. 9; and

FIG. 11 a perspective view of another embodiment of a planar transport device having a first platform and a second platform.

### DETAILED DESCRIPTION

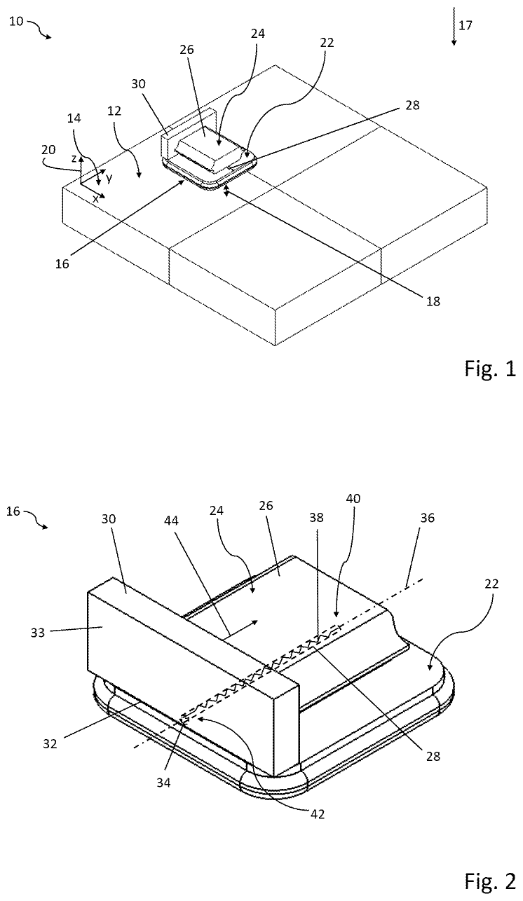

A planar transport device is denoted as a whole with the reference number 10 in the drawing. The planar transport device 10 comprises a driving surface 12, defining an x-y plane 14, on which a first platform 16 is arranged, cf. FIG. 1.

The driving surface 12 is oriented in particular perpendicular to the direction of gravity 17.

The first platform 16 is coupled electromagnetically to the driving surface 12 and can be driven to move on the driving surface 12. Optionally, a spacing 18 can also be set between the first platform 16 and the driving surface 12, so that the first platform 16 can be positioned freely in a space which is thus defined not only by the x-y plane 14, but also by a z-axis 20 perpendicular to it.

The first platform 16 comprises a platform side 22 facing away from the driving surface 12, being associated with a payload space 24. A payload 26 for transport can be arranged in the payload space 24.

The first platform 16 furthermore comprises a first linear guide 28, which extends along the platform side 22 and in which an inertial element 30 is movably mounted.

The payload 26 and the inertial element 30 can be moved together with the first platform 16. Thus, it is possible to transport the payload 26 to freely selected positions of the driving surface 12.

The inertial element 30 is cuboidal in shape, in particular, and situated in an initial state in physical proximity to a first outer edge 32 of the platform side 22, cf. FIG. 2. Preferably, one lengthwise side 33 of the inertial element 30 is oriented parallel to the first outer edge 32 of the platform side 22. In this way, the inertial element 30 forms a boundary of the payload space 24.

The inertial element 30 comprises a sliding block 34 or is connected to a sliding block 34. The sliding block 34 is led in the first linear guide 28 of the first platform 16 and can move—together with the inertial element 30—along a first guiding axis 36 of the first linear guide 28. Preferably, the friction against the contact surfaces between the sliding block 34 and a wall of the first linear guide 28 is minimized. This can be achieved, for example, by the choice of materials with a low coefficient of friction and/or by a surface treatment, such as a low-friction coating of the surfaces.

Furthermore, a return device 38 is situated in a free space of the first linear guide 28, being fashioned for example as a spring. The spring is braced against the first platform 16 at a first end 40 of the first linear guide 28 and connected to the inertial element 30 at a second end 42 of the first linear guide 28.

If the first platform 16 is moving at a constant speed, the inertial element 30 will remain in an initial state in the region of the first outer edge 32.

If the first platform 16 is decelerated or braked from a state of motion, the inertial element 30 on account of its inertial mass will retain a portion of its kinetic energy and be deflected along the first linear guide 28. The inertial element 30 will move relative to the platform side 22 and in particular relative to the payload space 24. The direction of movement of the inertial element 30 will define an effective direction 44 of the inertial element 30.

If the first platform 16 is moving during the braking in the direction of the first guiding axis 36 of the first linear guide 28, the direction of movement and the effective direction 44 of the inertial element 30 will coincide. However, it is also conceivable for the direction of movement of the first platform 16 and the guiding axis 36 of the first linear guide 28 to make an angle which is less than 90°. The effective direction 44 of the inertial element 30 will then deviate by this angle from the direction of movement of the first platform 16.

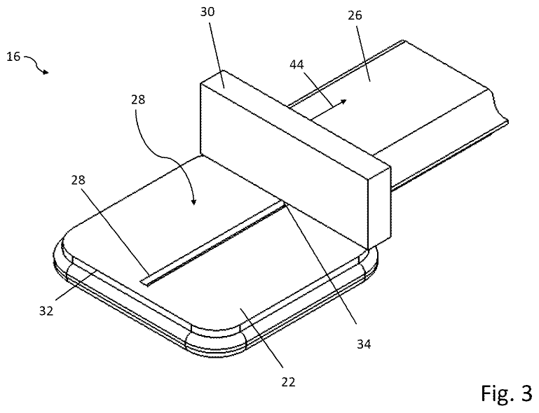

Thanks to the deflection of the inertial element 30 relative to the payload space 24, a portion of the kinetic energy of the inertial element 30 is transferred to the payload space 24. If a payload 26 is situated in the payload space 24, this payload 26 will be accelerated in the effective direction 44 by the transfer of a portion of the kinetic energy of the inertial element 30 to the payload 26 and be removed from the first platform 16 by being ejected from the payload space 24, cf. FIG. 3.

The deflection of the inertial element 30 is accompanied by a tensioning of the return device 38. In this process, a further portion of the kinetic energy of the inertial element 30 is taken up by the return device 38 and stored temporarily as tensioning energy. The tensioned return device 38 strikes against the inertial element 30 with a restoring force, which acts contrary to the effective direction 44 of the inertial element 30. Thanks to the restoring force of the return device 38, the inertial element 30 is returned to its initial nondeflected state. A new payload can then be arranged in the payload space 24.

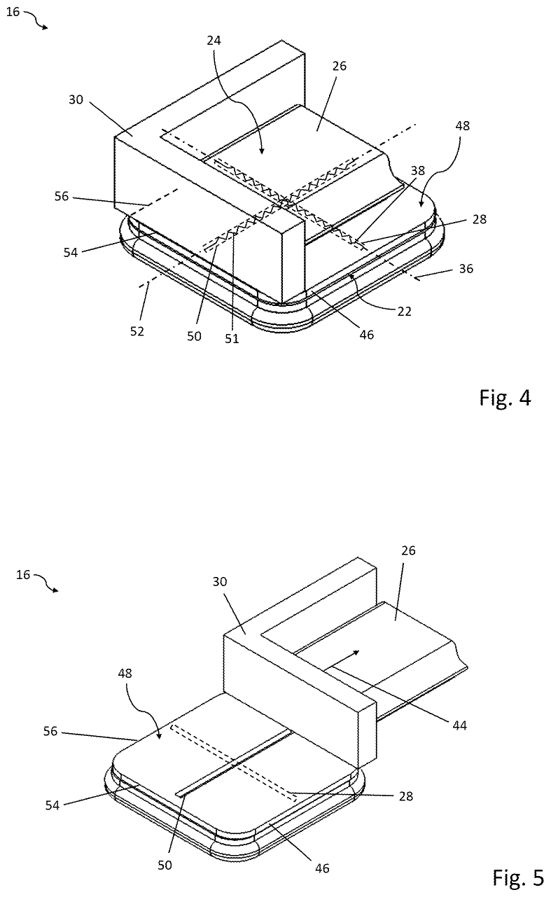

FIG. 4 shows a further embodiment of a planar transport device 10. The first platform 16 comprises a flat intermediate element 46, which is arranged between the platform side 22 and the inertial element 30. The intermediate element 46 extends in parallel with the platform side 22.

The intermediate element 46 comprises an intermediate element side 48, facing away from the driving surface 12, being associated with a payload space 24. A payload 26 for transport can be arranged in the payload space 24.

The intermediate element 46 is mounted in the first linear guide 28 of the first platform 16 and can move relative to the platform side 22.

The intermediate element 46 comprises a second linear guide 50 having a second guiding axis 52. The inertial element 30 is movably mounted in the second linear guide 50 of the intermediate element 46. The first guiding axis 36 of the first linear guide 28 and the second guiding axis 52 of the second linear guide 50 are oriented perpendicular to each other.

The first linear guide 28 and the second linear guide 50 each contain a return device 38 and 51, for example, they each contain a spring.

The inertial element 30 is L-shaped and extends along a first outer edge 54 and an adjacent second outer edge 56 of the intermediate element side 48. The second outer edge 56 is indicated schematically in FIG. 4. The L-shaped inertial element 30 bounds the payload space 24 on two mutually perpendicular sides.

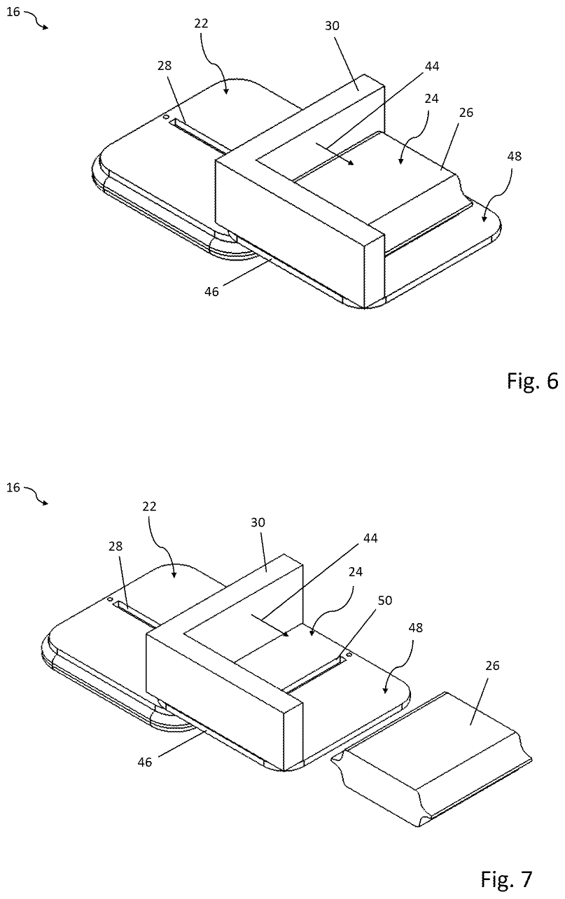

Upon movement of the first platform 16 in the direction of the second guiding axis 52 followed by deceleration of the platform 16, the inertial element 30 will be deflected along the second linear guide 50 and move relative to the intermediate element side 48 and the payload space 24. The intermediate element 46 in this process remains in its initial position, cf. FIG. 5.

If a payload 26 is arranged in the payload space 24, a portion of the kinetic energy of the inertial element 30 will be transferred to the payload 26. The payload 26 will be accelerated by this in the effective direction 44 and removed from the first platform 16, cf. FIG. 5.

Upon movement of the first platform 16 in the direction of the first guiding axis 36 followed by deceleration of the first platform 16, the inertial element 30 and the intermediate element 46 will be deflected together, cf. FIG. 6.

The inertial element 30 and the intermediate element 46 will move along the first linear guide 28 relative to the platform side 22 in the effective direction 44. The payload 26 remains in contact with the intermediate element side 48 up to the maximum deflection of the inertial element 30 and the intermediate element 46.

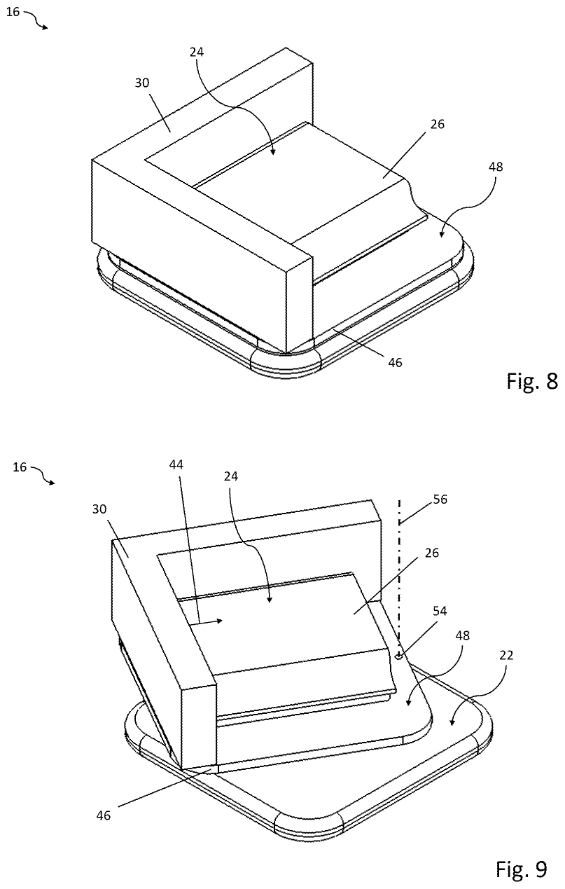

Once the maximum deflection is achieved, the payload 26 moves further relative to the inertial element 30 and the intermediate element 46 and is removed from the intermediate element side 48 and from the payload space 24 by ejecting, cf. FIG. 7.

FIGS. 8 to 10 show a further embodiment of the planar transport device 10, there being arranged a pivot 54 on the first platform 16, by means of which the intermediate element 46 is mounted on the platform 16 rotatably about an axis of rotation 56. The axis of rotation 56 is oriented, in particular, perpendicular to the intermediate element side 48. Moreover, the axis of rotation 56 is preferably offset laterally from the center of gravity of the first platform 16.

The intermediate element 46 comprises a second linear guide 50, already explained above with reference to FIGS. 4 to 7, in which the inertial element 30 is movably mounted.

The pivot 54 enables an orienting of the intermediate element 46 about the axis of rotation 56 regardless of the orientation of the first platform 16 about a z-axis 20. In particular, the orientation of the linear guide 50 can be adjusted. In this way, the orientation of the effective direction 44 of the inertial element 30 can be assigned regardless of the orientation of the first platform 16, cf. FIG. 9.

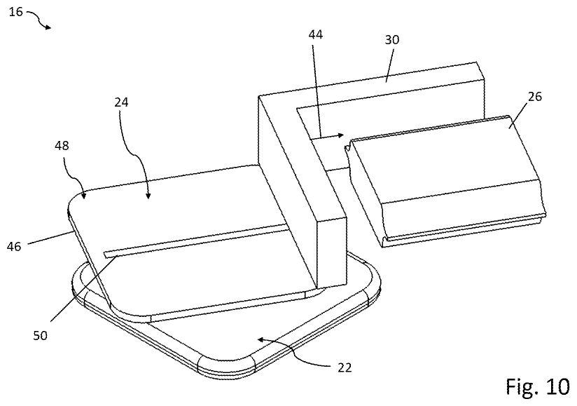

If the first platform 16 moves on the driving surface 12 and is then decelerated, the inertial element 30 will move relative to the intermediate element 46 and the payload space 24. A portion of the kinetic energy of the inertial element 30 will be transferred to the payload 26 in the manner already described above and the payload will be removed from the payload space 24, cf. FIG. 10.

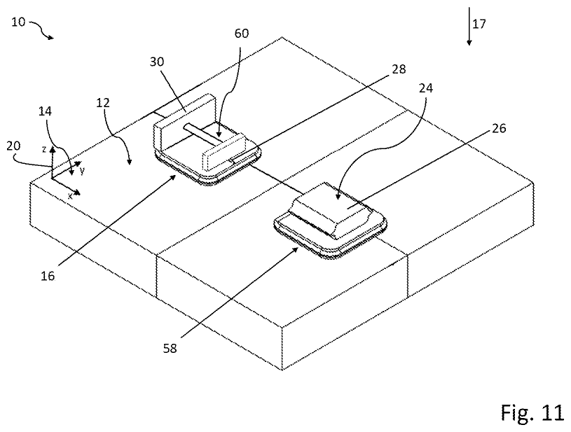

FIG. 11 shows a further embodiment of a planar transport device 10. The planar transport device 10 comprises a first platform 16 and a second platform 58. Both platforms 16 and 58 are electromagnetically coupled to the driving surface 12 and can move independently of each other in the x-y plane 14.

In a departure from the above-described embodiments, a payload space 24 is associated not with the first platform 16, but rather with the second platform 58. The payload 26 can be arranged in the payload space 24 and it can be transported by the second platform 58.

The first platform 16 comprises the inertial element 30, which is movably mounted in the first linear guide 28. The inertial element 30 has an extension section 60, and the extension section 60 extends in particular along and/or parallel to the first guiding axis 36 of the first linear guide 28.

Upon inertia-induced deflection of the inertial element 30, the extension section 60 of the inertial element 30 extends beyond the first platform 16 and transfers at least a portion of the kinetic energy of the inertial element 30 to the payload space 24 of the second platform 58, so that a payload 26 situated there can be ejected from the payload space.

1. A planar transport device (10) having a driving surface (12) and having at least one first platform (16), which can be coupled electromagnetically to the driving surface (12) and moved parallel to the driving surface (12), wherein the planar transport device (10) comprises a payload space (24) for arrangement of a payload (26), wherein the planar transport device (10) comprises an inertial element (30) which is movable relative to the first platform (16), wherein the movable inertial element (30) and the payload space (24) are oriented relative to each other such that, upon deceleration of the first platform (16) due to movement of the inertial element (30) in an effective direction (44) relative to the first platform (16), at least some kinetic energy of the inertial element (30) can be transferred to the payload space (24).

2. The planar transport device (10) according to claim 1, wherein the planar transport device (10) comprises a return device (38), which moves the inertial element (30) contrary to the effective direction (44).

3. The planar transport device (10) according to claim 1, wherein the first platform (16) comprises a first linear guide (28) for guidance of the inertial element (30) or an intermediate element (46), serving for placement of the inertial element (30).

4. The planar transport device (10) according to claim 3, wherein the intermediate element (46) comprises a second linear guide (50) for guidance of the inertial element (30).

5. The planar transport device (10) according to claim 4, wherein the first linear guide (28) extends along a first guiding axis (36), the second linear guide (50) extends along a second guiding axis (52), and the first guiding axis (36) and the second guiding axis (52) are oriented perpendicular to each other.

6. The planar transport device (10) according to claim 3, wherein the intermediate element (46) is mounted rotatably on the first platform (16) about an axis of rotation (56).

7. The planar transport device (10) according to claim 1, wherein the payload space (24) is associated with the at least one first platform (16).

8. The planar transport device (10) according to claim 7, wherein the inertial element (30) forms, at least in an initial state, an at least partial boundary of the payload space (24).

9. The planar transport device (10) according to claim 1, wherein the payload space (24) is associated with a second platform (58), which can be coupled electromagnetically to the driving surface (12) and which can move parallel to the driving surface (12).

10. The planar transport device (10) according to claim 9, wherein the inertial element (30) comprises an extension section (60) extending in the effective direction (44), which extends beyond the first platform (16) at least in a deflected state of the inertial element (30).

11. A method for operating a planar transport device (10) according to claim 1, wherein a payload (26) is arranged in the payload space (24), wherein the movable inertial element (30) and the payload space (24) are oriented relative to each other such that, upon deceleration of the platform (16) due to movement of the inertial element (30) relative to the platform (16), at least some kinetic energy of the inertial element (30) is transferred to the payload space (24) and to the payload (26).

12. The method according to claim 11, wherein upon movement of the platform (16) in an x-direction of the driving surface (12) and then a deceleration of the platform (16), the inertial element (30) moves relative to an intermediate element (46), and wherein upon movement of the platform (16) in a y-direction of the driving surface (12), perpendicular to the x-direction of the driving surface (12), and then a deceleration of the platform (16), the inertial element (30) moves together with the intermediate element (46) relative to the platform (16).
